(19) United States
(12) Patent Application Publication
(10) Pub. No.: US 2025/0047477 A1
(43) Pub. Date: Feb. 6, 2025

(54) USING DEVICE-SPECIFIC KEY FOR DERIVATION

(71) Applicant: Coinbase, Inc., Oakland, CA (US)

(72) Inventors: Guy Pe'er, Talmey Yechiel (IL); Yehuda Lindell, Petah Tikva (IL); Pavel Zakharov, Montreal (CA)

(21) Appl. No.: 18/228,586

(22) Filed: Jul. 31, 2023

(51) Int. Cl. H04L 9/08; H04L 9/32

(52) U.S. Cl. CPC H04L 9/0866; H04L 9/0822; H04L 9/0863; H04L 9/3236

(57) ABSTRACT

Methods, systems, and devices for using a device-specific key for key derivation are described. A user device receives, via a client application on the user device, a request to perform a cryptographic operation using a cryptographic key. The user device causes, after receiving the request, a secure subsystem of the user device to generate the cryptographic key using multiple iterations of a key derivation function and a device-specific key as input into the key derivation function. The device-specific key is stored in the secure subsystem. The user device performs a cryptographic operation using the cryptographic key.

### FIELD OF TECHNOLOGY

The present disclosure relates generally to data management, including techniques for using device-specific key for derivation.

### BACKGROUND

Blockchains and related technologies may be employed to support recordation of ownership of digital assets, such as cryptocurrencies, fungible tokens, non-fungible tokens (NFTs), and the like. Generally, peer-to-peer networks support transaction validation and recordation of transfer of such digital assets on blockchains. Various types of consensus mechanisms may be implemented by the peer-to-peer networks to confirm transactions and to add blocks of transactions to the blockchain networks. Example consensus mechanisms include the proof-of-work consensus mechanism implemented by the Bitcoin network and the proof-of-stake mechanism implemented by the Ethereum network. Some nodes of a blockchain network may be associated with a digital asset exchange, which may be accessed by users to trade digital assets or trade a fiat currency for a digital asset.

### BRIEF DESCRIPTION OF THE DRAWINGS

FIG. 1 illustrates an example of a computing environment that supports using device-specific key for derivation in accordance with aspects of the present disclosure.

FIG. 2 shows an example of a computing environment that supports using device-specific key for derivation in accordance with aspects of the present disclosure.

FIG. 3 shows an example of a process flow that supports using device-specific key for derivation in accordance with aspects of the present disclosure.

FIG. 4 shows a block diagram of an apparatus that supports using device-specific key for derivation in accordance with aspects of the present disclosure.

FIG. 5 shows a block diagram of a client application that supports using device-specific key for derivation in accordance with aspects of the present disclosure.

FIG. 6 shows a diagram of a system including a device that supports using device-specific key for derivation in accordance with aspects of the present disclosure.

FIGS. 7 through 9 show flowcharts illustrating methods that support using device-specific key for derivation in accordance with aspects of the present disclosure.

### DETAILED DESCRIPTION

Cryptography may be used to facilitate secure data exchange over a channel. Encryption is a cryptographic process that may be used to protect sensitive data that is transmitted or that is stored on systems (e.g., databases). The encryption process involves converting an original representation of the information, such as plaintext, into a different form of the information, which may be referred to as ciphertext, by using an encryption key. A decryption key may reverse the encryption process to reveal the original representation of the information, and encryption/decryption keys may be symmetric or asymmetric. A symmetric decryption key is the same key that is used to encrypt the information and an asymmetric decryption key is a different key than the key used for encryption. Asymmetric encryption, which involves two different keys, may be more secure than the symmetric encryption. Asymmetric encryption may involve using the same key for encryption and decryption. That is, symmetric encryption may involve the sharing of a key between two parties, but asymmetric encryption may not involve transmission of a key.

In some cases, the decryption key to access the information may be susceptible to attacks, where unauthorized users (e.g., attackers) gain access to the decryption key for ultimately accessing the information. For example, attacks may involve key derivation from a passcode (or access to a master key using the passcode), where one or more keys are derived from the passcode. An attacker may obtain or guess the passcode, which may be simple for a user to easily remember, and attempt different key derivation techniques (e.g., cryptographic algorithms) to derive the decryption key for accessing the information. For example, the attacker may execute a brute force attack, where the attacker applies one or more variations of symbols, words, or numbers on the passcode until the decryption key is successfully determined.

Attackers may also use specialized software or supercomputers to expedite the process of obtaining the key. The passcode may be transferrable or otherwise accessible to the supercomputer. For example, a supercomputer may be a computer with a high level of performance as compared to a general-purpose computer, and the supercomputer may have a high operational rate for one or more purposes, such as the purpose of key derivation operations. The supercomputer may access the passcode and perform millions of key derivation operations (e.g., hash-based functions or iterations) on the passcode in a few seconds, and thus, may efficiently derive the key associated with the passcode. Accordingly, passcodes (or other keys that are accessible using the passcode) may transferrable or otherwise easily obtainable, and as such, may not be secure and may be susceptible to attacks.

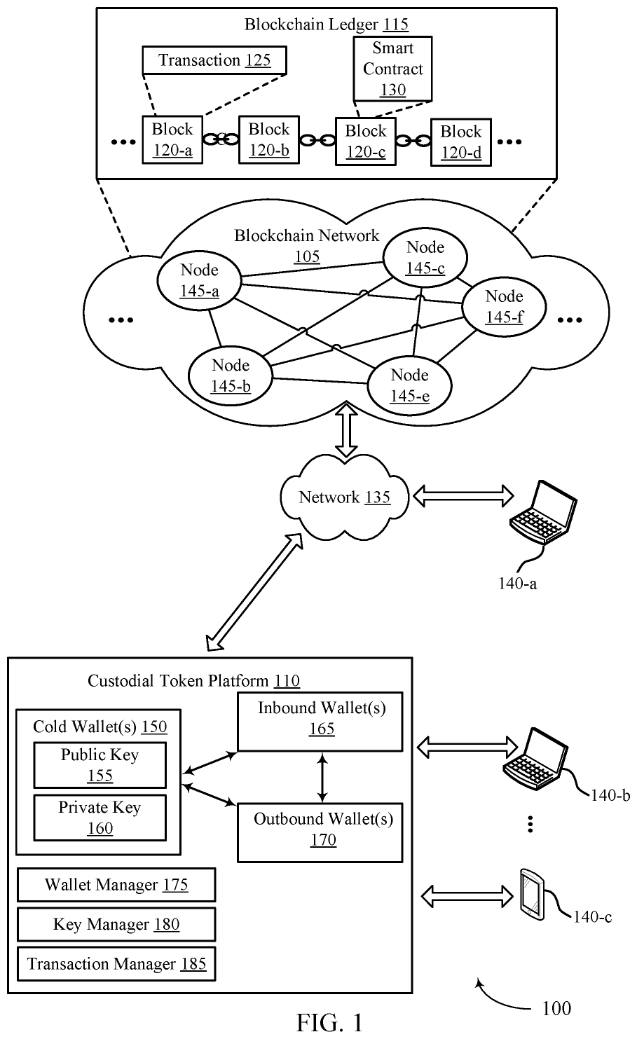

FIG. 1 illustrates an example of a computing environment 100 that supports using device-specific key for derivation in accordance with aspects of the present disclosure. The computing environment 100 may include a blockchain network 105 that supports a blockchain ledger 115, a custodial token platform 110, and one or more computing devices 140, which may be in communication with one another via a network 135.

The network 135 may allow the one or more computing devices 140, one or more nodes 145 of the blockchain network 105, and the custodial token platform 110 to communicate (e.g., exchange information) with one another. The network 135 may include aspects of one or more wired networks (e.g., the Internet), one or more wireless networks (e.g., cellular networks), or any combination thereof. The network 135 may include aspects of one or more public networks or private networks, as well as secured or unsecured networks, or any combination thereof. The network 135 also may include any quantity of communications links and any quantity of hubs, bridges, routers, switches, ports or other physical or logical network components.

Nodes 145 of the blockchain network 105 may generate, store, process, verify, or otherwise use data of the blockchain ledger 115. The nodes 145 of the blockchain network 105 may represent or be examples of computing systems or devices that implement or execute a blockchain application or program for peer-to-peer transaction and program execution. For example, the nodes 145 of the blockchain network 105 support recording of ownership of digital assets, such as cryptocurrencies, fungible tokens, non-fungible tokens (NFTs), and the like, and changes in ownership of the digital assets. The digital assets may be referred to as tokens, coins, crypto tokens, or the like. The nodes 145 may implement one or more types of consensus mechanisms to confirm transactions and to add blocks (e.g., blocks 120-a, 120-b, 120-c, and so forth) of transactions (or other data) to the blockchain ledger 115. Example consensus mechanisms include a proof-of-work consensus mechanism implemented by the Bitcoin network and a proof-of-stake consensus mechanism implemented by the Ethereum network.

When a device (e.g., the computing device 140-a, 140-b, or 140-c) associated with the blockchain network 105 executes or completes a transaction associated with a token supported by the blockchain ledger, the nodes 145 of the blockchain network 105 may execute a transfer instruction that broadcasts the transaction (e.g., data associated with the transaction) to the other nodes 145 of the blockchain network 105, which may execute the blockchain application to verify the transaction and add the transaction to a new block (e.g., the block 120-d) of a blockchain ledger (e.g., the blockchain ledger 115) of transactions after verification of the transaction. Using the implemented consensus mechanism, each node 145 may function to support maintaining an accurate blockchain ledger 115 and prevent fraudulent transactions.

The blockchain ledger 115 may include a record of each transaction (e.g., a transaction 125) between wallets (e.g., wallet addresses) associated with the blockchain network 105. Some blockchains may support smart contracts, such as smart contract 130, which may be an example of a sub-program that may be deployed to the blockchain and executed when one or more conditions defined in the smart contract 130 are satisfied. For example, the nodes 145 of the blockchain network 105 may execute one or more instructions of the smart contract 130 after a method or instruction defined in the smart contract 130 is called by another device. In some examples, the blockchain ledger 115 is referred to as a blockchain distributed data store.

A computing device 140 may be used to input information to or receive information from the computing system custodial token platform 110, the blockchain network 105, or both. For example, a user of the computing device 140-a may provide user inputs via the computing device 140-a, which may result in commands, data, or any combination thereof being communicated via the network 135 to the computing system custodial token platform 110, the blockchain network 105, or both. Additionally, or alternatively, a computing device 140-a may output (e.g., display) data or other information received from the custodial token platform 110, the blockchain network 105, or both. A user of a computing device 140-a may, for example, use the computing device 140-a to interact with one or more user interfaces (e.g., graphical user interfaces (GUIs)) to operate or otherwise interact with the custodial token platform 110, the blockchain network 105, or both.

A computing device 140 and/or a node 145 may be a stationary device (e.g., a desktop computer or access point) or a mobile device (e.g., a laptop computer, tablet computer, or cellular phone). In some examples, a computing device 140 and/or a node 145 may be a commercial computing device, such as a server or collection of servers. And in some examples, a computing device 140 and/or a node 145 may be a virtual device (e.g., a virtual machine).

Some blockchain protocols support layer one and layer two crypto tokens. A layer one token is a token that is supported by its own blockchain protocol, meaning that the layer one token (or a derivative thereof), may be used to pay transaction fees for transacting using the blockchain protocol. A layer two token is a token that is built on top of layer one, for example, using a smart contract 130 or a decentralized application (“Dapp”). The smart contract 130 or decentralized application may issue layer two tokens to various users based on various conditions, and the users may transact using the layer two tokens, but transaction fees may be based on the layer one token (or a derivative thereof).

The custodial token platform 110 may support exchange or trading of digital assets, fiat currencies, or both by users of the custodial token platform 110. The custodial token platform 110 may be accessed via website, web application, or applications that are installed on the one or more computing devices 140. The custodial token platform 110 may be configured to interact with one or more types of blockchain networks, such as the blockchain network 105, to support digital asset purchase, exchange, deposit, and withdrawal.

For example, users may create accounts associated with the custodial token platform 110 such as to support purchasing of a digital asset via a fiat currency, selling of a digital asset via fiat currency, or exchanging or trading of digital assets. A key management service (e.g., a key manager) of the custodial token platform 110 may create, manage, or otherwise use private keys that are associated with user wallets and internal wallets. For example, if a user wishes to withdraw a token associated with the user account to an external wallet address, key manager 180 may sign a transaction associated with a wallet of the user, and broadcast the signed transaction to nodes 145 of the blockchain network 105, as described herein. In some examples, a user does not have direct access to a private key associated with a wallet or account supported or managed by the custodial token platform 110. As such, user wallets of the custodial token platform 110 may be referred to non-custodial wallets or non-custodial addresses.

The custodial token platform 110 may create, manage, delete, or otherwise use various types of wallets to support digital asset exchange. For example, the custodial token platform 110 may maintain one or more internal cold wallets 150. The internal cold wallets 150 may be an example of an offline wallet, meaning that the cold wallet 150 is not directly coupled with other computing systems or the network 135 (e.g., at all times). The cold wallet 150 may be used by the custodial token platform 110 to ensure that the custodial token platform 110 is secure from losing assets via hacks or other types of unauthorized access and to ensure that the custodial token platform 110 has enough assets to cover any potential liabilities. The one or more cold wallets 150, as well as other wallets of the blockchain network 105 may be implemented using public key cryptography, such that the cold wallet 150 is associated with a public key 155 and a private key 160. The public key 155 may be used to publicly transact via the cold wallet 150, meaning that another wallet may enter the public key 155 into a transaction such as to move assets from the wallet to the cold wallet 150. The private key 160 may be used to verify (e.g., digitally sign) transactions that are transmitted from the cold wallet 150, and the digital signature may be used by nodes 145 to verify or authenticate the transaction. Other wallets of the custodial token platform 110 and/or the blockchain network 105 may similarly use aspects of public key cryptography.

The custodial token platform 110 may also create, manage, delete, or otherwise use inbound wallets 165 and outbound wallets 170. For example, a wallet manager 175 of the custodial token platform 110 may create a new inbound wallet 165 for each user or account of the custodial token platform 110 or for each inbound transaction (e.g., deposit transaction) for the custodial token platform 110. In some examples, the custodial token platform 110 may implement techniques to move digital asset between wallets of the digital asset exchange platform. Assets may be moved based on a schedule, based on asset thresholds, liquidity requirements, or a combination thereof. In some examples, movements or exchanges of assets internally to the custodial token platform 110 may be “off-chain” meaning that the transactions associated with the movement of the digital asset are not broadcast via the corresponding blockchain network (e.g., blockchain network 105). In such cases, the custodial token platform 110 may maintain an internal accounting (e.g., ledger) of assets that are associated with the various wallets and/or user accounts.

As used herein, a wallet, such as inbound wallets 165 and outbound wallets 170 may be associated with a wallet address, which may be an example of a public key, as described herein. The wallets may be associated with a private key that is used to sign transactions and messages associated with the wallet. A wallet may also be associated with various user interface components and functionality. For example, some wallets may be associated with or leverage functionality for transmitting crypto tokens by allowing a user to enter a transaction amount, a receiver address, etc. into a user interface and clicking or activating a UI component such that the transaction is broadcast via the corresponding blockchain network via a node (e.g., a node 145) associated with the wallet. As used herein, “wallet” and “address” may be used interchangeably.

In some cases, the custodial token platform 110 may implement a transaction manager 185 that supports monitoring of one or more blockchains, such as the blockchain ledger 115, for incoming transactions associated with addresses managed by the custodial token platform 110 and creating and broadcasting on-blockchain transactions when a user or customer sends a digital asset (e.g., a withdrawal). For example, the transaction manager 185 may monitor the addressees of the customers for transfer of layer one or layer two tokens supported by the blockchain ledger 115 to the addresses managed by the custodial token platform 110. As another example, when a user is withdrawing a digital asset, such as a layer one or layer two token, to an external wallet (e.g., an address that is not managed by the custodial token platform 110 or an address for which the custodial token platform 110 does not have access to the associated private key), the transaction manager 185 may create and broadcast the transaction to one or more other nodes 145 of the blockchain network 105 in accordance with the blockchain application associated with the blockchain network 105. As such, the transaction manager 185, or an associated component of the custodial token platform 110 may function as a node 145 of the blockchain network 105.

As described herein, the custodial token platform may implement and support various wallets including the inbound wallets 165, the outbound wallets 170, and the cold wallets 150. Further, the custodial token platform 110 may implement techniques to maintain and manage balances of the various wallets. In some examples, the balances of the various wallets are configured to support security and liquidity. For example, the custodial token platform 110 may implement transactions that move crypto tokens between the inbound wallets 165 and the outbound wallets 170. These transactions may be referred to as “flush” transactions and may occur on a periodic or scheduled basis.

As described herein, various transactions may be broadcast to the blockchain ledger 115 to cause transfer of crypto tokens, to call smart contracts, to deploy smart contracts etc. In some examples, these transactions may also be referred to as messages. That is, the custodial token platform 110 may broadcast a message to the blockchain network 105 to cause transfer of tokens between wallets managed by the custodial token platform 110 to cause transfer of tokens from a wallet managed by the custodial token platform 110 to an external wallet, to deploy a smart contract (e.g., a self-executing program), or to call a smart contract.

Additionally, a user may access the custodial token platform 110 via a custodial application to purchase, sell, exchange, or trade digital assets, such as crypto tokens and the like, in a secure manner. Securely performing transactions in the custodial token platform 110 may involve using cryptographic keys, such as encryption keys, decryption keys, or both. For example, a device 140 associated with a user may receive a request to broadcast a message to a blockchain network supported distributed data store (e.g., associated with the blockchain ledger 115 and the blockchain network 105), such as a request to sign a message. Signing the message may involve using a private key to sign a message, which allows a public key to be used to verify the user or wallet. In some cases, cryptographic keys for performing cryptographic operations associated with the transactions may be backed up or encrypted on a device using a key derived from another key or passcode. However, this passcode may be transferrable or accessible, and in some cases, may be obtained by attackers. The attackers may subject the passcode to various key derivation algorithms to obtain the decryption key, which may be used to decrypt encrypted information such as the key backup. In some examples, the passcode may be used to generate encryption keys.

Techniques described herein address the forgoing by supporting a secure key derivation algorithm that uses a device-specific key. For example, the device-specific key may be stored in secure subsystem of the device 140, such that the device-specific key cannot be transferred from the device 140 or accessible outside of the secure subsystem. In this manner, key derivation functions may be executed in the secure subsystem so that the cryptographic key is securely derived at the secure subsystem of the device 140 and using information specific to the device 140. In some cases, the secure subsystem may also be inaccessible to other portions of the device 140 to ensure security, for example, since the other portions may be accessible to devices external to the device 140. In some cases, the secure subsystem may be relatively less susceptible to attacks since most attacks occur on data, such as passcodes, communicated or transferred between systems. Moreover, attacks may involve key derivation functions that are efficiently performed within a short period of time to prevent detection of the attack. In some cases, the secure subsystem of the device 140 may perform key derivation functions at a relatively less efficient pace than at an attacking device, which may be a supercomputer. The relatively longer period for securely deriving the cryptographic key at the secure subsystem may further deter attackers from attempting to perform key derivation functions at the computing device 140. Further, the device 140 with the secure device-specific key in the secure subsystem may be less accessible to others, including the attackers performing cyberattacks, since the device 140 is generally with the user associated with the device 140 (e.g., user carrying mobile device). Accordingly, attacks on cryptographic operations may be avoided, ensuring secure transactions and data storage. The key derivation techniques described herein are described with respect to the custodial token platform 110, but it should be understood that the key derivation techniques may be performed on any data in any environment. It should also be understood that the key derivation techniques may be executed in other secure hardware, such as any device with a secure, externally inaccessible portion.

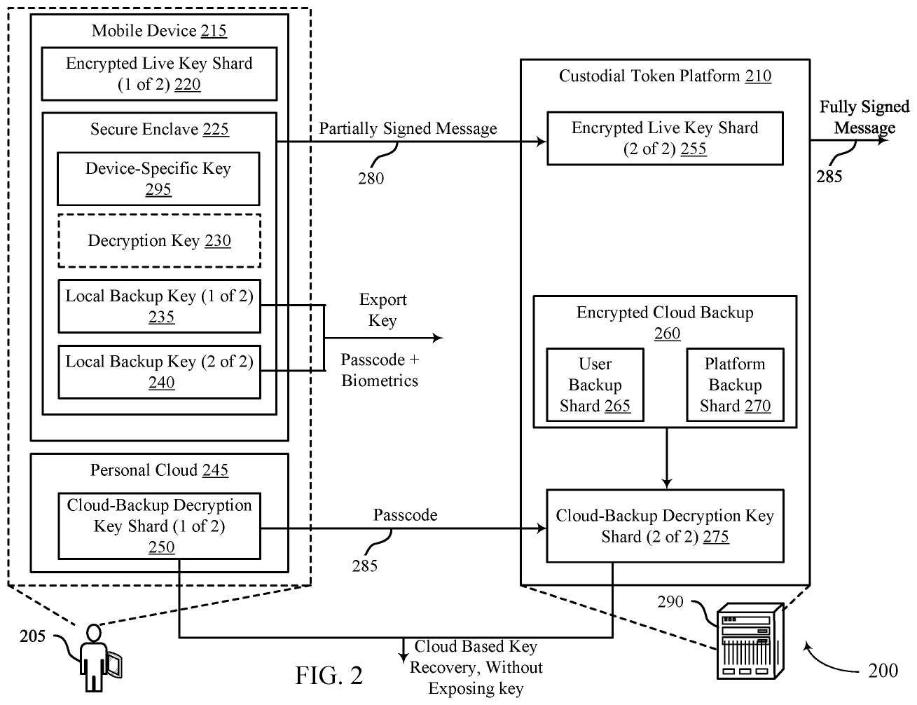

FIG. 2 shows an example of a computing environment 200 that supports using a device-specific key for derivation in accordance with aspects of the present disclosure. The computing environment 200 includes a user 205 and a custodial token platform 210. The custodial token platform 210 may be an example of the custodial token platform 110 as described with respect to FIG. 1 and may be supported by one or more servers, such as server 290. The user 205 may access services provided by the custodial token platform 210 via a mobile device 215. For example, the mobile device 215 may execute an application associated with the custodial token platform 210 (e.g., custodial token platform application) or may access the custodial token platform 210 via a web browser.

The mobile device 215 may use a multi-party computation (MPC) wallet application to interact with and access services of the custodial token platform 210. The MPC wallet application may utilize a secure enclave 225 (e.g., a Trusted Execution Environment (TEE), trusted platform module (TPM), or the like), which may be an example of a secure subsystem, to generate and use cryptographic keys (e.g., encryption and decryption keys). In some examples, the wallet application may access a development kit to generate keys and key shards (e.g., pieces of a cryptographic key). Additionally, or alternatively, the mobile device 215 may receive cryptographic keys from another service or device. However, in some examples, the other service or device may not access the secure enclave 225.

As described herein, the wallet application of the mobile device 215 may be associated with a device-specific key 295. The device-specific key 295 may be a unique key specifically for the mobile device 215. That is, the secure enclave 225 may store different unique device-specific keys 295 for different mobile devices 215. Key derivation functions may be applied to the device-specific key 295 to generate a cryptographic key, such as an encryption key or a decryption key 230. The key derivation functions may include hashing (e.g., hash-based function), Password-Based Key Derivation Function 1 and 2 (PBKDF1 and PBKDF2), and the like. The PBKDFs may include a pseudorandom function, such as hash-based message authentication code (HMAC), that is applied to the input device-specific key 295 along with a salt value (e.g., random data that is used as an additional input). The process may be repeated multiple times (e.g., one thousand times, five thousand times, etc.) to derive a cryptographic key, which can then be used as a cryptographic key in subsequent cryptographic operations. In some examples, the cryptographic key is generated each time a cryptographic operation is requested. Additionally, in some examples, the key derivation functions may vary for each cryptographic key generation (e.g., PBKDF1 instead of PBKDF2, different values to apply, etc.). In some examples, the generated encryption key may encrypt the local backup keys 235 and 240. In additional or alternative examples, as discussed herein, the generated decryption key 230 may decrypt keys in the secure enclave 225 and export them.

Since the device-specific key 295 is stored in the secure enclave 225 (e.g., secure subsystem) of the mobile device 215 that is inaccessible to other devices, the device-specific key 295 may not be transferred from the mobile device 215 or accessible outside of the secure enclave 225. In this manner, key derivation functions may be executed in the secure enclave 225 so that the cryptographic key is securely derived at the secure enclave 225. In some cases, the secure enclave 225 may also be inaccessible to other portions of the mobile device 215 to ensure security, for example, since the other portions may be accessible to devices external to the mobile device 215. Moreover, attacks may involve key derivation functions that are efficiently performed within a short period of time to prevent detection of the attack. In some cases, the secure enclave 225 may perform key derivation functions at a relatively less efficient pace than at an attacking device, which may be a supercomputer. For example, the mobile device 215 may perform an iteration of the key derivation in 5 seconds whereas the attacking supercomputer may perform an iteration in 3 milliseconds. The relatively longer period for securely deriving the cryptographic key at the secure enclave 225 may further deter attackers from attempting to perform key derivation functions at the mobile device 215. Further, the mobile device 215 with the secure device-specific key 295 in the secure enclave 225 may be less accessible to others, including the attackers since the mobile device 215 is generally with the user 205 associated with the mobile device 215. Accordingly, attacks on cryptographic operations may be avoided using the device-specific key 295 in the secure enclave 225, ensuring secure transactions and data storage.

In some examples, such as the generated cryptographic key being the decryption key 230, the decryption key 230 may be used to decrypt encrypted data that is stored on, accessible to, or associated with the mobile device 215. For example, the decryption key 230, along with one or more passcodes and/or one or more biometric authentication methods, may be used to decrypt encrypted data or keys, export the decrypted data or keys (e.g., local backup keys 235 and 240) to the custodial token platform 210 or another device. The passcode may be a code or password known to the user 205 and the biometrics may include authentication methods to verify biological characteristics (e.g., facial recognition, fingerprint identification, etc.).

In some examples, key derivation functions applied to the device-specific key 295 may generate the cryptographic key. As will be discussed herein, the cryptographic key (e.g., local backup key 235, local backup key 240, or both) may be exported to the custodial token platform 210 or another device, which may use the keys to perform secure custodial token platform-related transactions (e.g., wallet transactions). For example, the local backup keys 235 may be backups corresponding to the key shard 220 the key shard 255 (e.g., for MPC operations), and the key shards 220 and 255 may be used to sign a message at the mobile device 215 and the custodial token platform 210. Thus, the signing of the message using the key shard 220 may result in a partially signed message 280 that is transmitted to the custodial token platform 210. The partially signed message 280 may be signed using the key shard 225 resulting in a fully signed message 285 that is broadcast to the custodial token platform 210 via the blockchain network. Additionally, or alternatively, the mobile device 215 may perform cryptographic operations using a private key that is not split into key shards, and a backup of the private key may be stored in or in association with the secure enclave 225 and encrypted using the decryption key 230 that is derived using the techniques described herein.

As described herein, the wallet application of the mobile device 215 may be associated with a public key and a private key which may be protected using the cryptographic key (e.g., the decryption key 230) generated based on the device-specific key 295. To support the MPC techniques described herein, the private key may be divided into one or multiple key shards including encrypted live key shard 220 and encrypted live key shard 255. After dividing the private key into multiple key shards, decrypting the key shards 220 and 255 using the generated decryption key 230 via the device-specific key 295, the mobile device 215 may communicate portions of the key shards to target devices or system. For example, the mobile device 215 may communicate the key shard 255 to the custodial token platform 210. In some examples, the key shard 255 is communicated in a secure manner, such as by encrypting and transmitting the key shard 255. That is, the mobile device 215 may encrypt the key shard 255 using a public key associated with the custodial token platform 210, and the custodial token platform 210 may decrypt the encrypted key shard 255 using a corresponding private key. In some examples, the custodial token platform 210 may store the key shard 255 in a key store in association with an account corresponding to the user 205 and/or in association with a public key for the wallet application on the mobile device. In additional or alternative examples, the key shard 220 or the corresponding backup key 235 may be encrypted using the cryptographic key generated based on the device-specific key 295 or decrypted using the decryption key 230, which is generated using the device-specific key 295, as previously mentioned.

In one example use of the key deriving techniques described herein, a user may wish to transfer a crypto token from the wallet address associated with the wallet application on the mobile device 215 to another address via a blockchain network (e.g., blockchain network 105 of FIG. 1). Using a user interface wallet application on the user device, the user 205 may enter the recipient address, the token type, amount, gas fees, etc., and after acceptance of a generated message, the mobile device 215 may generate a decryption key 230 from the device-specific key 295 in the secure enclave 225, decrypt the key shard 220, sign the message using the decrypted shard, and transmit the message to the custodial token platform 210 (e.g., one or more servers supporting the custodial token platform 210) via signed message 280. Signing the message at the mobile device using the key shard 220 results in a partially signed message. The message is partially signed, because another party may not be able to verify that the message is validly signed using the corresponding public key.

After receiving the partially signed message 280, the custodial token platform 210 may sign the partially signed message using the key shard 255 to generate a fully signed message 285. The fully signed message 285 may then be broadcasted, by the custodial token platform 210, to the blockchain network (e.g., blockchain network 105 of FIG. 1). The message may be a transaction that is configured to transfer the crypto token from the public key (e.g., wallet address) associated with the user 205 (e.g., via the wallet application on the user device) to another address, such as an address associated with a different wallet or a smart contract address.

As such, using these techniques, the devices or hardware of the mobile device 215 that are external to the secure enclave 225, may not be able to access or obtain the device-specific key 295, which is used to generate the cryptographic key each time the cryptographic key is requested. The device-specific key 295 facilitates a secure cryptographic operation based on the secure key generation. Accordingly, using the key deriving techniques described herein, the keys may be securely generated to prevent susceptibility to cryptographic attacks, while also maintaining additional security for the custodial token platform 210 that uses the securely-generated cryptographic keys for wallet transactions.

The mobile device 215 may also maintain backups of the private key/key shards. For example, a local backup key of the key shard 220 and a local backup key 240 of the key shard 255 may be stored in the secure enclave 225. These local backup keys 235 and 240 may be accessible only via a passcode, a biometric authentication (or another type of authentication technique), and the decryption key 230 that is based on the device-specific key 295. In some examples, the local backup keys 235 and 240 are stored in the secure enclave 225 and are accessible using enhanced security measures. In some examples, instead of the local backup keys 235 and 240 being stored, the entire private key is stored after being generated, or a mnemonic representing the private key or shards is stored.

As described, the key deriving functionality described herein supports export of the private keys or corresponding key shards after decrypting the keys using the decryption key 230, which is generated using the device-specific key 295. Export of the private key may be performed without using aspects of the custodial token platform 210 or without communicating with the custodial token platform 210. Thus, the user 205 may access the wallet application of the mobile device 215 (or another computing device with the wallet application) and request to perform an export of the private key. After receiving the indication, the wallet application on the mobile device 215 may prompt for a passcode, biometrics information, or both. A passcode may include an alphanumeric password, a numerical passcode, etc. The biometric information may include a face scan, a fingerprint, or the like. The passcode or biometric prompts may leverage authentication techniques supported by the operating system of the mobile device 215.

After authentication using a passcode, biometrics, or both (in addition to other authentication techniques), the mobile device 215 may obtain the private key from the secure enclave 225. For example, the mobile device 215 may generate the decryption key 230 based on the device-specific key 295 (and the passcode, in some examples), retrieve the local backup key 235 and the local backup key 240 from the secure enclave 225 using the generated decryption key 230. In some examples, the mobile device 215 may display the private key and/or the backup key shards (e.g., the local backup key 235 and the local backup key 240) or otherwise indicate the private key to the user 205, after applying the cryptographic key (e.g., the decryption key 230) generated based on the device-specific key 295. For example, the mobile device 215 displays the alphanumeric versions of the key shards, the entire private key, or a corresponding seed phrase (mnemonic). In the case of the seed phrase, the mobile device 215 may derive the seed phrase using the private key. The user may then use the private key to instantiate another wallet application or wallet device, such as self-custody wallet (hardware and/or software wallet). Thereafter, the user may access and/or transmit crypto tokens that are attributed to the public key associated with the private key using the instantiated wallet.

Thus, the decryption key 230 may be derived using the device-specific key 295 when the decryption key 230 requested (e.g., for an export operation). In some examples, the export operation request may result in the mobile device 215 (e.g., the custodial token platform application) transmitting a request to the secure enclave 225, and the request may indicate a key identifier, a key derivation function, the passcode, a quantity of iterations, etc. that is used to derive the decryption key 230. The secure enclave 225 may derive the decryption key 230 according to the request and provide the decryption key 230 or use the decryption key to decrypt the key that is to be exported or otherwise used.

In some examples, personal cloud 245 and encrypted cloud backup 260 may be used in cases where the user 205 loses a device. Thus, a user may backup the key shard 220 to a personal backup location, such as the personal cloud 245, as key shard 250. The user may get a new device, and install the wallet application, and retrieve the key shard 250 from the personal cloud 245. The user may then authenticate (e.g., by entering passcode) and the custodial token platform 210 may decrypt the encrypted cloud backup 260 that includes a user backup shard 265 (which may correspond to the key shard 220) and the backup shard 270 (which may correspond to the key shard 255) to generate key shard 275. The cryptographic key that is generated for retrieving these keys for the backup operation, may be generated using the device-specific key 295, as previously discussed. Thus, the user wallet application may be restored.

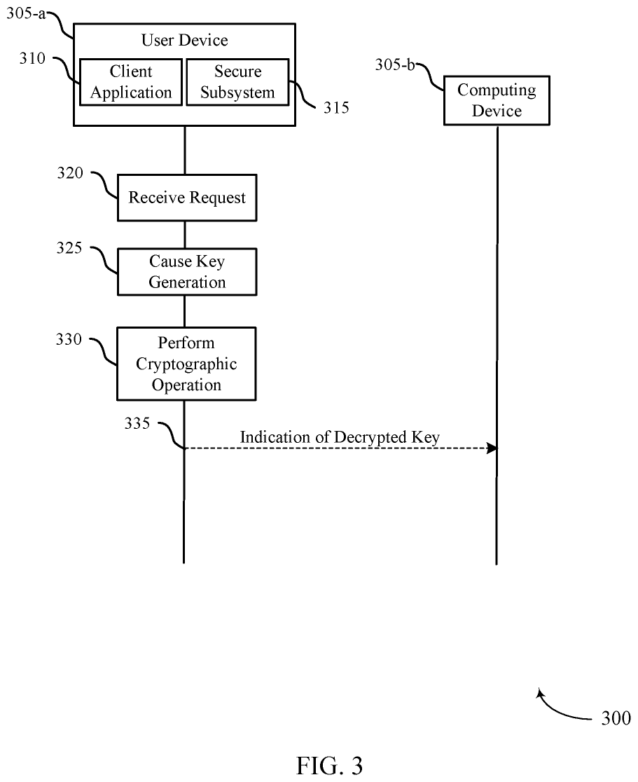

FIG. 3 shows an example of a process flow 300 that supports using device-specific key for derivation in accordance with aspects of the present disclosure. The process flow 300 includes a user device 305-a and a user device 305-b, which may be examples of the computing devices as described herein (e.g., computing device 140 of FIG. 1). The user devices 305-a may include one or more client applications (e.g., client application 310), which may be examples of client applications that are associated with or used to access aspects of a custodial token platform as described herein. The user devices 305 may also include a secure subsystem (e.g., secure subsystem 315 of user device 305-a) In the following description of the process flow 300, the operations between the user devices 305, may be transmitted in a different order than the example order shown, or the operations performed may be performed in different orders or at different times. Some operations may also be omitted from the process flow 300, and other operations may be added to the process flow 300.

At 320, the user device 305-a may receive, via the client application 310 (e.g., custodial token platform application) on the user device 305-a, a request to perform a cryptographic operation using a cryptographic key. For example, the user may access the client application and indicate the request to perform the cryptographic operation. In some examples, the user may activate a key export process using the client application 310. In some examples, the user device 305-a may receive, via the client application 310 of the user device 305-a, an input including a passcode. For example, the client application 310 may prompt for the passcode after the user selects or activates the key export procedure. At 325, the user device 305-a may cause, after receiving the request to perform the cryptographic operation, a secure subsystem of the user device 305-a to generate the cryptographic key. In some examples, causing the secure subsystem to generate the cryptographic key may involve the client application 310 transmitting, to the secure subsystem 315, the information that indicates the key derivation function and an iteration count for the key derivation function. In some examples, the information may be stored on the user device 305-a (e.g., user device 305-a is preconfigured with the information). The cryptographic key may be generated using multiple iterations of one or more key derivation functions and a device-specific key as input into the one or more key derivation functions. That is, the device-specific key and/or the passcode (and the output of a prior iteration of the key derivation function) may be input into each iteration of the key derivation function. The device-specific key may be stored in the secure subsystem 315 of the user device 305-a, and the device specific key may be inaccessible to external device and in some examples, also inaccessible to other parts of the user device 305-a. In this manner, the cryptographic key that is generated using the device-specific key may be secure and less susceptible to attacks. In particular, the secure subsystem may be relatively less susceptible to attacks since most attacks occur on data, such as passcodes, communicated or transferred between systems. Moreover, attacks may involve key derivation functions that are efficiently performed within a short period of time to prevent detection of the cyberattack. In some cases, the secure subsystem of the device 305-a may perform key derivation functions at a relatively less efficient pace than at an attacking device, such as a supercomputer. The relatively longer period for securely deriving the key at the secure subsystem may further deter attackers from attempting to perform key derivation functions at the user device 305-a. Further, the secure subsystem of the device 305-a with the secure device-specific key may be less accessible to others (e.g., other users not associated with the user device 305-a), including the attackers. Accordingly, less secure cryptographic operations using a cryptography key may be avoided.

The secure subsystem 315 of the user device 305-a may generate the cryptographic key using the device-specific key, as discussed with respect to FIG. 2. In some examples, the device-specific key may be limited from being removed from the secure subsystem. For example, the user device 305-a may use the device-specific key stored in the secure system of the user device 305-a (e.g., the secure enclave) and execute the key derivation functions to generate the cryptographic key, which may be an encryption key or a decryption key based on the cryptographic operation requested. In some examples, the key derivation function includes PBKDF 1, PBKDF 2, hash-based function, or any combination thereof. In some examples, each iteration of the key derivation function executed within the secure subsystem utilizes the device-specific key as the input.

At 330, the user device 305-a may perform the requested cryptographic operation. For example, the cryptographic operation may include encryption or decryption of keys in the secure subsystem or stored elsewhere in the user device 305-a. Additionally, or alternatively, the cryptographic operation may include encryption of data to be transmitted, or exporting a cryptographic key, etc. In some examples, performing the cryptographic operation may involve decrypting a second cryptographic key using the cryptographic key and transmitting an indication of the decrypted second cryptographic key. In additional or alternative examples, the cryptographic operation may include a handshake operation, an encryption operation, a decryption operation, transmitting a secure message, or any combination thereof.

At 335, the user device 305-a may transmit an indication of the decrypted key. For example, the user device 305-a may display an indication of the decrypted key such that the user may enter the indication into the user device 305-a. The operations at 335 may be performed based on execution of a key export process.

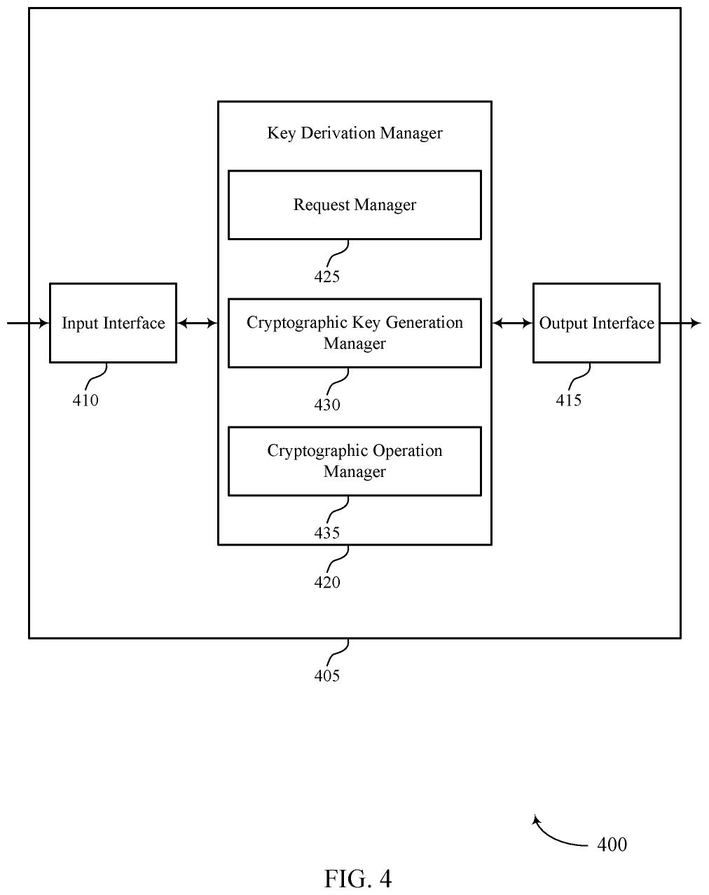

FIG. 4 shows a block diagram 400 of a system 405 that supports using device-specific key for derivation in accordance with aspects of the present disclosure. The system 405 may include an input interface 410, an output interface 415, and a key derivation manager 420. The system 405 may be an example of aspects of a user device as described herein. The system 405, or one or more components of the system 405 (e.g., the input interface 410, the output interface 415, and the key derivation manager 420), may include at least one processor, which may be coupled with at least one memory, to support the described techniques. Each of these components may be in communication with one another (e.g., via one or more buses, communications links, communications interfaces, or any combination thereof).

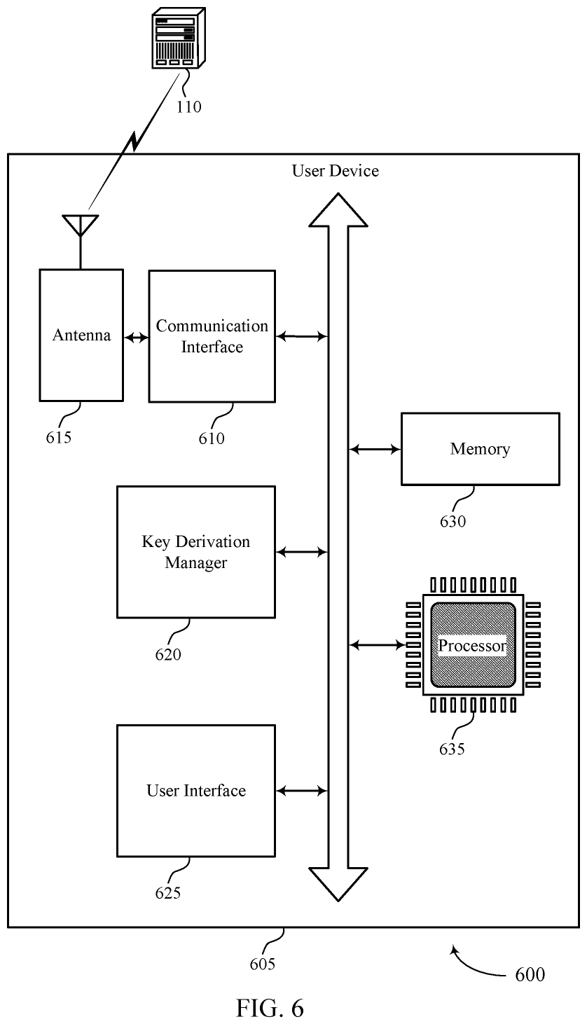

The input interface 410 may manage input signaling for the system 405. For example, the input interface 410 may receive input signaling (e.g., messages, packets, data, instructions, commands, transactions, or any other form of encoded information) from other systems or devices. The input interface 410 may send signaling corresponding to (e.g., representative of or otherwise based on) such input signaling to other components of the system 405 for processing. For example, the input interface 410 may transmit such corresponding signaling to the key derivation manager 420 to support using device-specific key for derivation. In some cases, the input interface 410 may be a component of a communication interface 610 as described with reference to FIG. 6.

For example, the key derivation manager 420 may include a request manager 425, a cryptographic key generation manager 430, a cryptographic operation manager 435, or any combination thereof. In some examples, the key derivation manager 420, or various components thereof, may be configured to perform various operations (e.g., receiving, monitoring, transmitting) using or otherwise in cooperation with the input interface 410, the output interface 415, or both. For example, the key derivation manager 420 may receive information from the input interface 410, send information to the output interface 415, or be integrated in combination with the input interface 410, the output interface, or both to receive information, transmit information, or perform various other operations as described herein.

The key derivation manager 420 may support key management in accordance with examples as disclosed herein. The request manager 425 may be configured as or otherwise support a means for receiving, via a client application on a user device, a request to perform a cryptographic operation using a cryptographic key. The cryptographic key generation manager 430 may be configured as or otherwise support a means for causing, after receiving the request, a secure subsystem of the user device to generate the cryptographic key using a plurality of iterations of a key derivation function and a device-specific key as input into the key derivation function, wherein the device-specific key is stored in the secure subsystem. The cryptographic operation manager 435 may be configured as or otherwise support a means for performing a cryptographic operation using the cryptographic key.

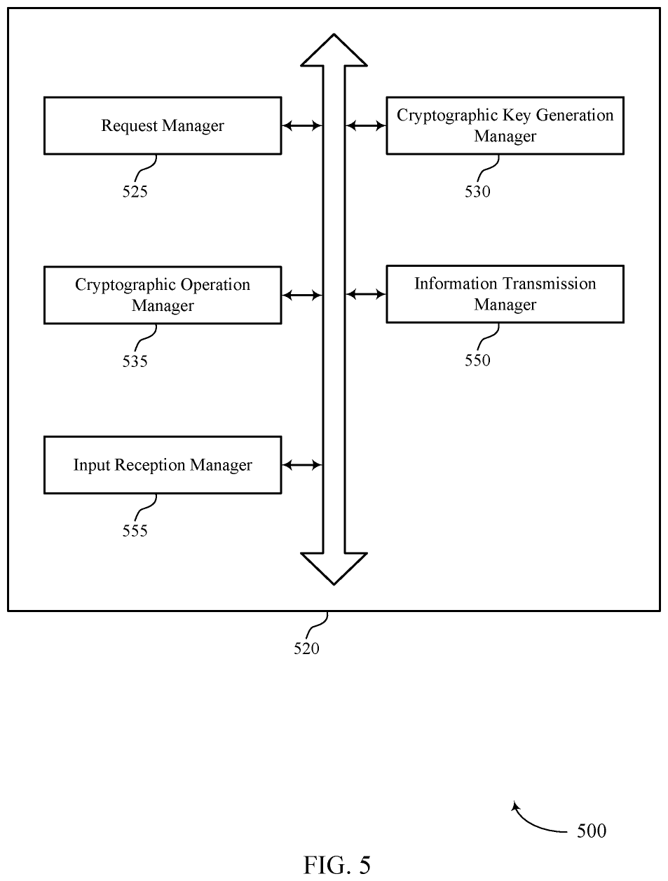

FIG. 5 shows a block diagram 500 of a key derivation manager 520 that supports using device-specific key for derivation in accordance with aspects of the present disclosure. The key derivation manager 520 may be an example of aspects of a client application or a key derivation manager 420, or both, as described herein. The key derivation manager 520, or various components thereof, may be an example of means for performing various aspects of using device-specific key for derivation as described herein. For example, the key derivation manager 520 may include a request manager 525, a cryptographic key generation manager 530, a cryptographic operation manager 535, an information transmission manager 550, an input reception manager 555, or any combination thereof. Each of these components may be in communication with one another (e.g., via one or more buses, communications links, communications interfaces, or any combination thereof).

The key derivation manager 520 may support key management in accordance with examples as disclosed herein. The request manager 525 may be configured as or otherwise support a means for receiving, via a client application on a user device, a request to perform a cryptographic operation using a cryptographic key. The cryptographic key generation manager 530 may be configured as or otherwise support a means for causing, after receiving the request, a secure subsystem of the user device to generate the cryptographic key using a plurality of iterations of a key derivation function and a device-specific key as input into the key derivation function, wherein the device-specific key is stored in the secure subsystem. The cryptographic operation manager 535 may be configured as or otherwise support a means for performing a cryptographic operation using the cryptographic key.

In some examples, each iteration of the key derivation function executed within the secure subsystem utilizes the device-specific key as the input.

In some examples, to support performing the cryptographic operation, the request manager 525 may be configured as or otherwise support a means for decrypting a second cryptographic key using the cryptographic key and transmitting an indication of the decrypted second cryptographic key.

In some examples, to support receiving the request, the request manager 525 may be configured as or otherwise support a means for receiving, from the client application that is associated with a blockchain wallet, a request to export the second cryptographic key, wherein the second cryptographic key is decrypted after receiving the request to export the second cryptographic key.

In some examples, the second cryptographic key comprises a backup of another key or another key shard that is used to perform cryptographic operations for blockchain messages.

In some examples, the key derivation function comprises Password-Based Key Derivation Function (PBKDF) 1, PBKDF 2, hash-based function, or any combination thereof. In some examples, the device-specific key is limited from being removed from the secure subsystem.

In some examples, the cryptographic operation comprises a handshake operation, an encryption operation, a decryption operation, transmitting a secure message, or any combination thereof.

In some examples, to support causing the secure subsystem to generate the cryptographic key, the information transmission manager 550 may be configured as or otherwise support a means for transmitting, to the secure subsystem, information that indicates the key derivation function and an iteration count for the key derivation function.

In some examples, the input reception manager 555 may be configured as or otherwise support a means for receiving, via the client application, an input comprising a passcode, where the passcode is also an input to the key derivation function.

FIG. 6 shows a diagram of a system 600 including a system 605 that supports using device-specific key for derivation in accordance with aspects of the present disclosure. The system 605 may be an example of or include the components of a system 405 as described herein. For example, the system 605 may be an example of a user device as described herein. The system 605 may include components for performing cryptographic operations, interfacing with a custodial token platform, and the like, as described herein. The system 605 may include a client application and/or a secure subsystem, as described herein. The system 605 may include components for transmitting and receiving communications, such as a key derivation manager 620, a communication interface 610, an antenna 615, a user interface 625, at least one memory 630, and at least one processor 635. Each of these components may be in communication with one another (e.g., via one or more buses, communications links, communications interfaces, or any combination thereof).

The communication interface 610 may manage input and output signals for the system 605 via the antenna 615. For example, the communication interface 610 may enable the system 605 to exchange information (e.g., input information, output information, or both) with other systems or devices, such as custodial token platform 110 (e.g., supported by one or more servers), via one or more wired or wireless communication links. The communication interface 610 may also utilize or interact with antenna 615 to support communication with other systems or devices. In some cases, the communication interface 610 may represent a physical connection or port to an external peripheral, such as a hardware wallet device. In some cases, the communication interface 610 may utilize an operating system such as iOS®, ANDROID®, MS-DOS®, MS-WINDOWS®, OS/2®, UNIX®, LINUX®, or another known operating system. The communication interface 610 may be implemented as part of the processor 635.

In some cases, the system 605 may include a single antenna 615. However, in some other cases, the system 605 may have more than one antenna 615, which may be capable of concurrently transmitting or receiving multiple wireless transmissions. The communication interface 610 may communicate bi-directionally, via the one or more antennas 615, wired, or wireless links as described herein. For example, the communication interface 610 may represent a wireless transceiver and may communicate bi-directionally with another wireless transceiver. The communication interface 610 may also include a modem to modulate the packets, to provide the modulated packets to one or more antennas 615 for transmission, and to demodulate packets received from the one or more antennas 615.

The user interface 625 may represent interact with a keyboard, a mouse, a touchscreen, a microphone, or a similar device or component. In some cases, a user may interact with the user interface 625. In other cases, the user interface 625 may operate automatically without user interaction. The user interface 625 may display or output information such as information received from other systems or devices or information to be transmitted to other systems or devices.

The memory 630 may include RAM and ROM. The memory 630 may store computer-readable, computer-executable software including instructions that, when executed, cause at least one processor 635 to perform various functions described herein. In some cases, the memory 630 may contain, among other things, a BIOS which may control basic hardware or software operation such as the interaction with peripheral components or devices. The memory 630 may be an example of a single memory or multiple memories. For example, the system 605 may include one or more memories 630.

The processor 635 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 635 may be configured to operate a memory array using a memory controller. In other cases, a memory controller may be integrated into the processor 635. The processor 635 may be configured to execute computer-readable instructions stored in at least one memory 630 to perform various functions (e.g., functions or tasks supporting a method and system for using device-specific key for derivation). Though a single processor 635 is depicted in the example of FIG. 6, it is to be understood that the system 605 may include any quantity of one or more of processors 635 and that a group of processors 635 may collectively perform one or more functions ascribed herein to a processor, such as the processor 635. The processor 635 may be an example of a single processor or multiple processors. For example, the system 605 may include one or more processors 635.

The key derivation manager 620 may support key management in accordance with examples as disclosed herein. For example, the key derivation manager 620 may be configured as or otherwise support a means for receiving, via a client application on a user device, a request to perform a cryptographic operation using a cryptographic key. The key derivation manager 620 may be configured as or otherwise support a means for causing, after receiving the request, a secure subsystem of the user device to generate the cryptographic key using a plurality of iterations of a key derivation function and a device-specific key as input into the key derivation function, wherein the device-specific key is stored in the secure subsystem. The key derivation manager 620 may be configured as or otherwise support a means for performing a cryptographic operation using the cryptographic key.

By including or configuring the key derivation manager 620 in accordance with examples as described herein, the system 605 may support techniques for using device-specific key for derivation to prevent or reduce susceptibility to attacks (e.g., an unauthorized user gaining access to cryptographic key by hacking or brute force attack).

The key derivation manager 620 may include an application (e.g., “app”), program, software, extension, or other component which is configured to facilitate communications with a custodial token platform 110 on a server, one or more nodes of a blockchain network 105, other system 605, and other devices or systems. For example, the key derivation manager 620 may be an application executable on the system 605, and the key derivation manager 620 may be configured to receive data from a custodial token platform 110, transmit data to the custodial token platform 110, process such data, and cause presentation of such data to a user via a user interface 625. The key derivation manager 620 may be an example of a wallet application, a wallet device, or both, and may be associated with a wallet address and may access or use a private key to sign messages to facilitate transfer of crypto tokens, messages, transactions, or the like via a blockchain distributed data store.

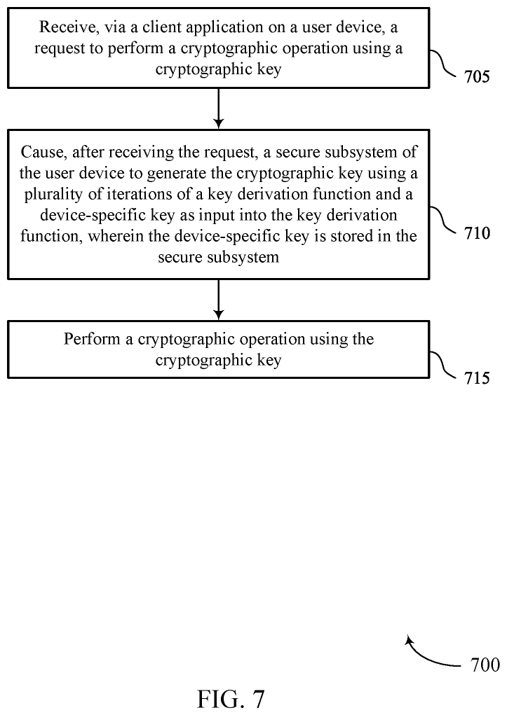

FIG. 7 shows a flowchart illustrating a method 700 that supports using device-specific key for derivation in accordance with aspects of the present disclosure. The operations of the method 700 may be implemented by a user device or its components as described herein. For example, the operations of the method 700 may be performed by a user device as described with reference to FIGS. 1 through 6. In some examples, a user device may execute a set of instructions to control the functional elements of the user device to perform the described functions. Additionally, or alternatively, the user device may perform aspects of the described functions using special-purpose hardware.

At 705, the method may include receiving, via a client application on a user device, a request to perform a cryptographic operation using a cryptographic key. The operations of block 705 may be performed in accordance with examples as disclosed herein. In some examples, aspects of the operations of 705 may be performed by a request manager 525 as described with reference to FIG. 5.

At 710, the method may include causing, after receiving the request, a secure subsystem of the user device to generate the cryptographic key using a plurality of iterations of a key derivation function and a device-specific key as input into the key derivation function, wherein the device-specific key is stored in the secure subsystem. The operations of block 710 may be performed in accordance with examples as disclosed herein. In some examples, aspects of the operations of 710 may be performed by a cryptographic key generation manager 530 as described with reference to FIG. 5.

At 715, the method may include performing a cryptographic operation using the cryptographic key. The operations of block 715 may be performed in accordance with examples as disclosed herein. In some examples, aspects of the operations of 715 may be performed by a cryptographic operation manager 535 as described with reference to FIG. 5.

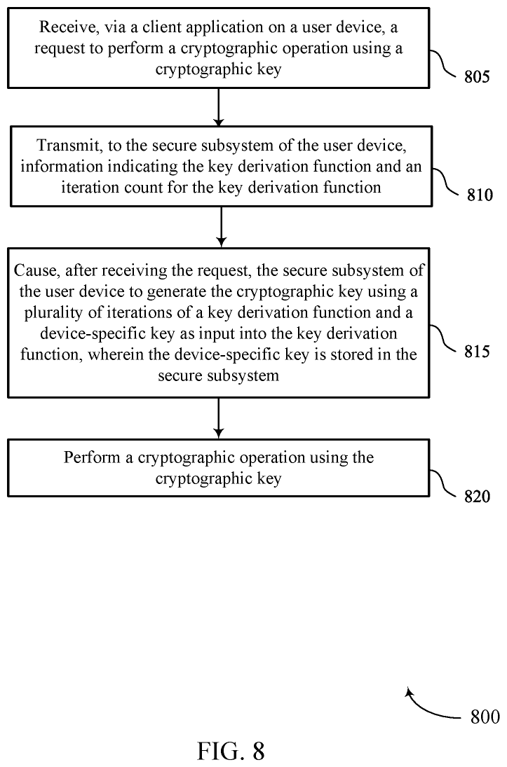

FIG. 8 shows a flowchart illustrating a method 800 that supports using device-specific key for derivation in accordance with aspects of the present disclosure. The operations of the method 800 may be implemented by a user device or its components as described herein. For example, the operations of the method 800 may be performed by a user device as described with reference to FIGS. 1 through 6. In some examples, a user device may execute a set of instructions to control the functional elements of the user device to perform the described functions. Additionally, or alternatively, the user device may perform aspects of the described functions using special-purpose hardware.

At 805, the method may include receiving, via a client application on a user device, a request to perform a cryptographic operation using a cryptographic key, for example for the broadcasting the message of 805. The operations of block 805 may be performed in accordance with examples as disclosed herein. In some examples, aspects of the operations of 805 may be performed by a request manager 525 as described with reference to FIG. 5.

At 810, the method may include transmitting, to the secure subsystem of the user device, information that indicates the key derivation function and an iteration count for the key derivation function. The information may be received from the custodial token platform (e.g., servers and/or stored on the user device). The operations of block 810 may be performed in accordance with examples as disclosed herein. In some examples, aspects of the operations of 810 may be performed by a request manager 525 as described with reference to FIG. 5.

At 815, the method may include causing, after receiving the request, the secure subsystem of the user device to generate the cryptographic key using a plurality of iterations of a key derivation function and a device-specific key as input into the key derivation function, wherein the device-specific key is stored in the secure subsystem. The operations of block 815 may be performed in accordance with examples as disclosed herein. In some examples, aspects of the operations of 815 may be performed by a cryptographic key generation manager 530 as described with reference to FIG. 5.

At 820, the method may include performing a cryptographic operation using the cryptographic key. The operations of block 820 may be performed in accordance with examples as disclosed herein. In some examples, aspects of the operations of 820 may be performed by a cryptographic operation manager 535 as described with reference to FIG. 5.

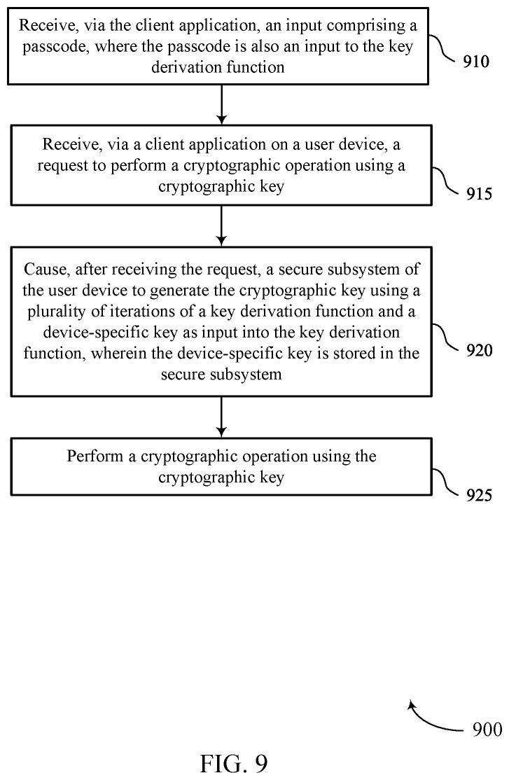

FIG. 9 shows a flowchart illustrating a method 900 that supports using device-specific key for derivation in accordance with aspects of the present disclosure. The operations of the method 900 may be implemented by a user device or its components as described herein. For example, the operations of the method 900 may be performed by a user device as described with reference to FIGS. 1 through 6. In some examples, a user device may execute a set of instructions to control the functional elements of the user device to perform the described functions. Additionally, or alternatively, the user device may perform aspects of the described functions using special-purpose hardware.

At 910, the method may include via the client application, an input including a passcode, where the passcode is also an input to the key derivation function. The operations of block 910 may be performed in accordance with examples as disclosed herein. In some examples, aspects of the operations of 910 may be performed by a request manager 525 as described with reference to FIG. 5.

At 915, the method may include receiving, via a client application on a user device, a request to perform a cryptographic operation using a cryptographic key. The operations of block 915 may be performed in accordance with examples as disclosed herein. In some examples, aspects of the operations of 915 may be performed by a request manager 525 as described with reference to FIG. 5.

At 920, the method may include causing, after receiving the request, a secure subsystem of the user device to generate the cryptographic key using a plurality of iterations of a key derivation function and a device-specific key as input into the key derivation function, wherein the device-specific key is stored in the secure subsystem. The operations of block 920 may be performed in accordance with examples as disclosed herein. In some examples, aspects of the operations of 920 may be performed by a cryptographic key generation manager 530 as described with reference to FIG. 5.

At 925, the method may include performing a cryptographic operation using the cryptographic key. The operations of block 925 may be performed in accordance with examples as disclosed herein. In some examples, aspects of the operations of 925 may be performed by a cryptographic operation manager 535 as described with reference to FIG. 5.

A method for key management is described. The method may include receiving, via a client application on a user device, a request to perform a cryptographic operation using a cryptographic key, causing, after receiving the request, a secure subsystem of the user device to generate the cryptographic key using a plurality of iterations of a key derivation function and a device-specific key as input into the key derivation function, wherein the device-specific key is stored in the secure subsystem, and performing a cryptographic operation using the cryptographic key.

An apparatus for key management is described. The apparatus may include at least one processor, at least one memory coupled with the at least one processor, and instructions stored in the at least one memory. The instructions may be executable by the at least one processor to cause the apparatus to receive, via a client application on a user device, a request to perform a cryptographic operation using a cryptographic key, cause, after receiving the request, a secure subsystem of the user device to generate the cryptographic key using a plurality of iterations of a key derivation function and a device-specific key as input into the key derivation function, wherein the device-specific key is stored in the secure subsystem, and perform a cryptographic operation using the cryptographic key.

Another apparatus for key management is described. The apparatus may include means for receiving, via a client application on a user device, a request to perform a cryptographic operation using a cryptographic key, means for causing, after receiving the request, a secure subsystem of the user device to generate the cryptographic key using a plurality of iterations of a key derivation function and a device-specific key as input into the key derivation function, wherein the device-specific key is stored in the secure subsystem, and means for performing a cryptographic operation using the cryptographic key.

A non-transitory computer-readable medium storing code for key management is described. The code may include instructions executable by a processor to receive, via a client application on a user device, a request to perform a cryptographic operation using a cryptographic key, cause, after receiving the request, a secure subsystem of the user device to generate the cryptographic key using a plurality of iterations of a key derivation function and a device-specific key as input into the key derivation function, wherein the device-specific key is stored in the secure subsystem, and perform a cryptographic operation using the cryptographic key.

In some examples of the method, apparatuses, and non-transitory computer-readable medium described herein, each iteration of the key derivation function executed within the secure subsystem utilizes the device-specific key as the input.

In some examples of the method, apparatuses, and non-transitory computer-readable medium described herein, performing the cryptographic operation may include operations, features, means, or instructions for decrypting a second cryptographic key using the cryptographic key and transmitting an indication of the decrypted second cryptographic key.

In some examples of the method, apparatuses, and non-transitory computer-readable medium described herein, receiving the request may include operations, features, means, or instructions for receiving, from the client application that is associated with a blockchain wallet, a request to export the second cryptographic key, wherein the second cryptographic key is decrypted after receiving the request to export the second cryptographic key.

In some examples of the method, apparatuses, and non-transitory computer-readable medium described herein, the second cryptographic key comprises a backup of another key or another key shard that is used to perform cryptographic operations for blockchain messages.

In some examples of the method, apparatuses, and non-transitory computer-readable medium described herein, the key derivation function comprises Password-Based Key Derivation Function (PBKDF) 1, PBKDF 2, hash-based function, or any combination thereof.

In some examples of the method, apparatuses, and non-transitory computer-readable medium described herein, the device-specific key may be limited from being removed from the secure subsystem.

In some examples of the method, apparatuses, and non-transitory computer-readable medium described herein, the cryptographic operation comprises a handshake operation, an encryption operation, a decryption operation, transmitting a secure message, or any combination thereof.

In some examples of the method, apparatuses, and non-transitory computer-readable medium described herein, causing the secure subsystem to generate the cryptographic key may include operations, features, means, or instructions for transmitting, to the secure subsystem, information that indicates the key derivation function and an iteration count for the key derivation function.

Some examples of the method, apparatuses, and non-transitory computer-readable medium described herein may further include operations, features, means, or instructions for receiving, via the client application, an input comprising a passcode, where the passcode is also an input to the key derivation function.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for key management, comprising:
receiving, via a client application on a user device, a request to perform a cryptographic operation using a cryptographic key;
causing, after receiving the request, a secure subsystem of the user device to generate the cryptographic key using a plurality of iterations of a key derivation function and a device-specific key as input into the key derivation function, wherein the device-specific key is stored in the secure subsystem; and
performing a cryptographic operation using the cryptographic key.

2. The method of claim 1, wherein each iteration of the key derivation function executed within the secure subsystem utilizes the device-specific key as the input.

3. The method of claim 1, wherein performing the cryptographic operation further comprises:
decrypting a second cryptographic key using the cryptographic key; and
transmitting an indication of the decrypted second cryptographic key.

4. The method of claim 3, wherein receiving the request comprises:
receiving, from the client application that is associated with a blockchain wallet, a request to export the second cryptographic key, wherein the second cryptographic key is decrypted after receiving the request to export the second cryptographic key.

5. The method of claim 3, wherein the second cryptographic key comprises a backup of another key or another key shard that is used to perform cryptographic operations for blockchain messages.

6. The method of claim 1, wherein the key derivation function comprises Password-Based Key Derivation Function (PBKDF) 1, PBKDF 2, hash-based function, or any combination thereof.

7. The method of claim 1, wherein the device-specific key is limited from being removed from the secure subsystem.

8. The method of claim 1, wherein the cryptographic operation comprises a handshake operation, an encryption operation, a decryption operation, transmitting a secure message, or any combination thereof.

9. The method of claim 1, wherein causing the secure subsystem to generate the cryptographic key comprises:
transmitting, to the secure subsystem, information that indicates the key derivation function and an iteration count for the key derivation function.

10. The method of claim 1, further comprising:
receiving, via the client application, an input comprising a passcode, wherein the passcode is also an input to the key derivation function.

11. An apparatus for key management, comprising:
one or more memories storing processor-executable code; and
one or more processors coupled with the one or more memories and individually or collectively operable to execute the code to cause the apparatus to:
receive, via a client application on a user device, a request to perform a cryptographic operation using a cryptographic key;
cause, after receiving the request, a secure subsystem of the user device to generate the cryptographic key using a plurality of iterations of a key derivation function and a device-specific key as input into the key derivation function, wherein the device-specific key is stored in the secure subsystem; and
perform a cryptographic operation using the cryptographic key.

12. The apparatus of claim 11, wherein each iteration of the key derivation function executed within the secure subsystem utilizes the device-specific key as the input.

13. The apparatus of claim 11, wherein, to perform the cryptographic operation, the one or more processors are individually or collectively further operable to execute the code to cause the apparatus to:
decrypt a second cryptographic key using the cryptographic key; and
transmit an indication of the decrypted second cryptographic key.

14. The apparatus of claim 13, wherein, to receive the request, the one or more processors are individually or collectively operable to execute the code to cause the apparatus to:
receive, from the client application that is associated with a blockchain wallet, a request to export the second cryptographic key, wherein the second cryptographic key is decrypted after receiving the request to export the second cryptographic key.

15. The apparatus of claim 13, wherein the second cryptographic key comprises a backup of another key or another key shard that is used to perform cryptographic operations for blockchain messages.

16. A non-transitory computer-readable medium storing code for key management, the code comprising instructions executable by one or more processors to:
receive, via a client application on a user device, a request to perform a cryptographic operation using a cryptographic key;
cause, after receiving the request, a secure subsystem of the user device to generate the cryptographic key using a plurality of iterations of a key derivation function and a device-specific key as input into the key derivation function, wherein the device-specific key is stored in the secure subsystem; and
perform a cryptographic operation using the cryptographic key.

17. The non-transitory computer-readable medium of claim 16, wherein each iteration of the key derivation function executed within the secure subsystem utilizes the device-specific key as the input.

18. The non-transitory computer-readable medium of claim 16, wherein the instructions to perform the cryptographic operation are further executable by the one or more processors to:
decrypt a second cryptographic key using the cryptographic key; and
transmit an indication of the decrypted second cryptographic key.

19. The non-transitory computer-readable medium of claim 18, wherein the instructions to receive the request are executable by the one or more processors to:
receive, from the client application that is associated with a blockchain wallet, a request to export the second cryptographic key, wherein the second cryptographic key is decrypted after receiving the request to export the second cryptographic key.

20. The non-transitory computer-readable medium of claim 18, wherein the second cryptographic key comprises a backup of another key or another key shard that is used to perform cryptographic operations for blockchain messages.
